(19) United States
(12) Patent Application Publication
(10) Pub. No.: US 2008/0100076 A1
(43) Pub. Date: May 1, 2008

(54) CARGO CARRYING SYSTEM

(76) Inventor: Steven Earl Potts, Vista, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/925,427

(22) Filed: Oct. 26, 2007

Related U.S. Application Data
(60) Provisional application No. 60/863,282, filed on Oct. 27, 2006.

(51) Int. Cl. B60P 3/00

(52) U.S. Cl. 296/3

(57) ABSTRACT

A cargo carrying system for use with a vehicle. The system includes a platform having roller members on an underside thereof to facilitate movement of the platform along the ground. Also included is a connection assembly which serves to permit the attachment of the platform to a vehicle. In one embodiment, both a first height adjustment mechanism and a separate, finely adjustable height mechanism are included between the connection assembly and the platform. Also included is an intermediate, slidable member used between the platform and connection member to facilitate the connection of the platform to the vehicle.

### CROSS-REFERENCE TO RELATED APPLICATIONS

This application claims benefit of U.S. provisional patent application Ser. No. 60/863,282, filed Oct. 27, 2006, which is herein incorporated by reference.

### BACKGROUND OF THE INVENTION

1. Field of the Invention

Embodiments described herein relate to a cargo carrying system for use with a motor vehicle. More particularly, embodiments relate to a dual purpose cargo carrying system which provides a platform for movement along a surface and attachment to a motor vehicle.

2. Description of the Related Art

Vehicle cargo carriers are well known in the art. One example involves a platform which is mountable at the rear of a motor vehicle, typically a pick up truck or a utility vehicle. These vehicles usually include hitch receivers already installed for use with trailers. The platform has sides and an insert portion matable with the trailer hitch receiver. The platform provides additional space for storage at the rear of the vehicle while not increasing the vehicle's overall width. Examples of prior art cargo carriers are described in U.S. Pat. Nos. 4,813,584, 6,099,035, and 5,427,289. Problems with the prior art cargo carriers are obvious. They are bulky, heavy, and difficult to install due to their size. These carriers must be installed while they are unloaded and then unloaded prior to being removed from the vehicle. Storage of the devices when they are not in use is problematic due to their weight and bulk, and they have no use whatsoever when not installed on a vehicle.

There is a need therefore, for a more versatile, easy to use cargo carrier for use by itself and/or with a motor vehicle.

### SUMMARY OF THE INVENTION

Embodiments described herein relate to a cargo carrying system for use with a vehicle. The system includes a platform having roller members on an underside thereof to facilitate movement of the platform along the ground. Also included is a connection assembly which serves to permit the attachment of the platform to a vehicle. The connection assembly includes a vehicle attachment member for connection to a vehicle and a platform attachment member for connection of the assembly to the platform. In one embodiment, both a first height adjustment mechanism and a separate, finely adjustable height mechanism are included between the connection assembly and the platform. Also included is an intermediate, slidable member used between the platform and connection member to facilitate the connection of the platform to the vehicle.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective, exploded view of the connection assembly of the invention including a vehicle insert portion and a platform insert portion.

FIG. 2 is a perspective view of the connection assembly as it appears prior to connection at the rear of a vehicle.

FIG. 3 is a perspective view showing the connection assembly installed at the rear of a vehicle.

FIG. 4 is a view of the underside of the platform.

FIG. 5 shows the connection assembly after connection to the vehicle but prior to connection to the platform.

FIG. 6 shows an intermediate sliding member extending between the platform insert portion of the connection assembly.

FIG. 7 shows the vehicle and connection assembly prior to connection to the platform.

FIG. 8 shows the platform insert portion of the assembly having been lowered to a level slightly below the level of the platform receiver.

FIG. 9 shows the connection assembly being connected to the platform via the extension of the intermediate sliding member.

FIG. 10 shows the platform having been lifted with a hand operated winch to a higher position relative to the rear of the vehicle.

FIG. 11 shows the connection assembly being connected to a platform.

FIG. 12 shows the connection assembly being connected to a platform.

FIG. 13 shows the connection assembly being connected to a platform having a ramp.

FIG. 14 shows the connection assembly being connected to a platform having a ramp.

FIG. 14A shows a hinge assembly for the ramp.

FIG. 15 is a perspective, exploded view of the connection assembly of the invention including a vehicle insert portion and a platform insert portion.

FIG. 15A is a perspective view of the upper portion of the connection assembly.

### DETAILED DESCRIPTION

One embodiment described herein is made up of two portions: a platform and a connection assembly for connection of the platform to a motor vehicle.

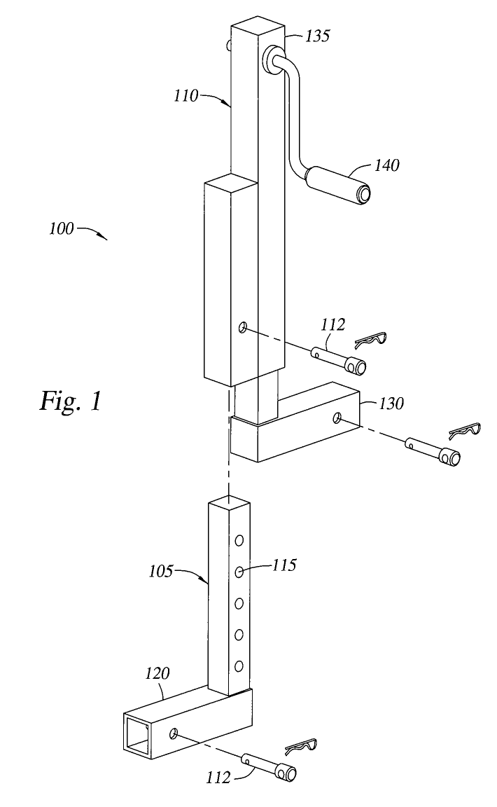

FIG. 1 is a perspective view of the connection assembly 100. The assembly includes a lower portion 105 constructed and arranged to extend telescopically downward from an upper portion 110. The lower portion is fixable at one of several locations with a pin 112 and apertures 115. The lower portion includes a platform insert 120 which extends horizontally and is intended to be inserted into a receiver of the platform as will be described herein. The upper portion 110 of the assembly includes a vehicle insert 130 which is intended to be inserted into a receiver located at the rear of a vehicle. In addition to the telescopic action of the lower portion, the connection assembly includes a mechanical winch 135 which is operated by a hand crank 140 to adjust the height of the platform insert relative to the vehicle insert. Mechanically operated winches are well known in the art and are often seen used in connection with trailers, boats, and other recreational vehicles to adjust the location of an object relative to a vehicle. Using the mechanical winch, the height of the platform insert 120 can be precisely adjusted relative to the height of the vehicle insert 130.

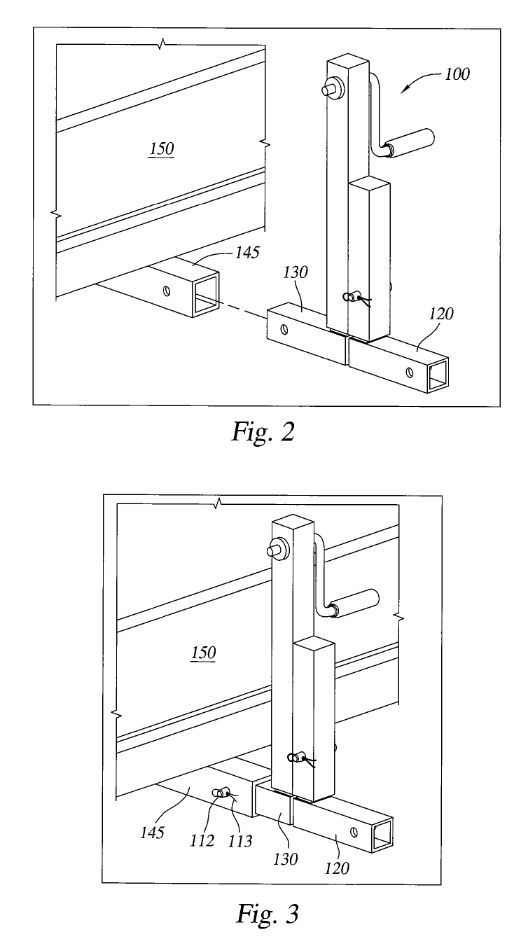

FIG. 2 is a perspective view showing the connection assembly 100 ready for installation at the rear of a vehicle 150 with the vehicle insert 130 and platform insert portion 120 set at an equal height. As illustrated, the vehicle insert 130 portion will be inserted into a vehicle receiver 145 and locked therein.

FIG. 3 is a perspective view illustrating the connection assembly 100 installed in the vehicle receiver 145. The vehicle insert 130 may be retained with a pin 112, aperture, and retainer wire 113.

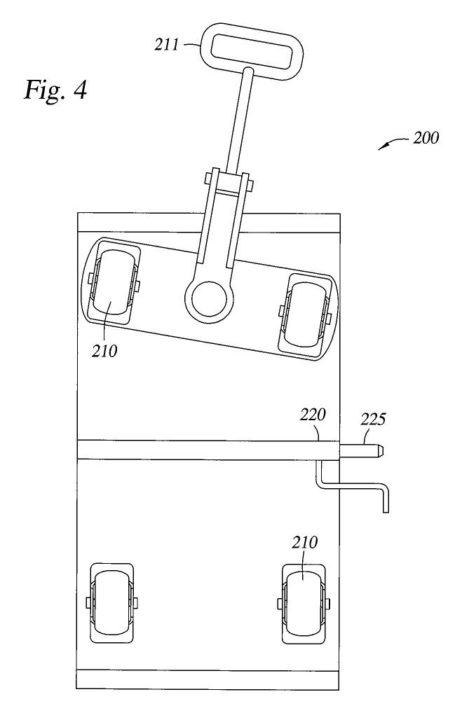

FIG. 4 is a view of the underside of the platform 200. As shown, the platform is rectangular in shape. The platform 200 may have four wheels 210 and a handle 211 for pulling, much like a child's wagon. Like a wagon (or a motor vehicle), the front wheels of the platform are pivotable, while the rear wheels are fixed at a position parallel to the longitudinal centerline of the platform. It should be appreciated that any number and combination of the wheels 210 may be used including, but not limited to, casters adapted to rotate 360 degrees and roll along the ground. The receiver portion 220 for mating with the connection assembly 100 may be located mid way along a side of the platform 200. It should be appreciated that any wheel configuration may be used so long as the platform is capable of easy manipulation once disconnected from the vehicle 150. The wheels 210 and/or the handle 211 may have a lock (not shown) adapted to maintain the wheels 210 and/or handle 211 in a stationary position during transport of the platform 200 by the vehicle 150.

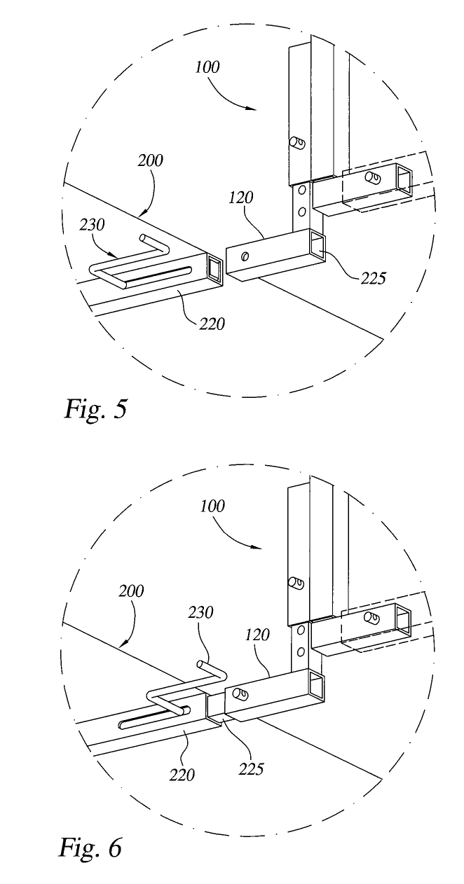

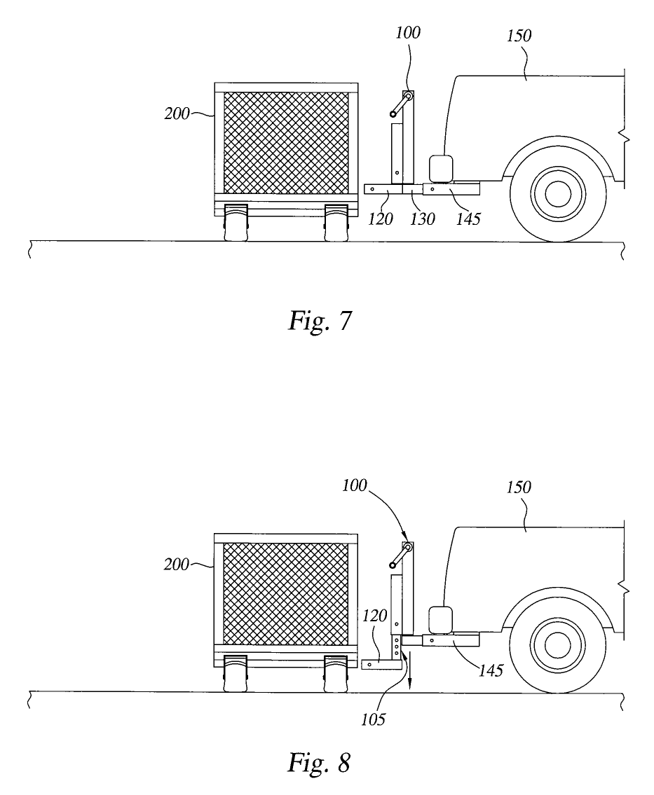

FIG. 5 is a perspective view of the connection assembly 100 prior to attachment to the platform 200. Rather than a single insert/receiver arrangement, the receiver portion 220 of the platform is equipped with an intermediate sliding member 225 that is manually extendable from the receiver with a hand-operated lever 230. The intermediate sliding member 225 is especially useful due to the design of the platform. Although the intermediate sliding member 225 is shown as being coupled to the receiver portion 220, it should be appreciated that the intermediate sliding member 225 may be integral with the platform insert 120, the vehicle insert 130, and/or the trailer hitch. When the platform 200 is attached via the connection assembly 100 to a vehicle 150, it is arranged with its long side running parallel to the rear bumper of the vehicle (FIGS. 7 and 8). Because the receiver portion 220 of the platform is located along its length, the sliding member 225 allows the user to avoid having to drag the platform to a position where the platform insert 120 of the connection assembly 100 is mated with the receiver portion 220 of the platform 200.

A comparison of FIGS. 5 and 6 shows the connection of the platform 200 to the connection assembly 100 and the use of the intermediate sliding member 225. In FIG. 5, the platform is shown adjacent the connection assembly 100. In FIG. 6, the intermediate sliding member 225 has been extended to mate with the platform insert portion 120 of the connection assembly 100 and is fixed using a pin 112 and aperture arrangement. The intermediate sliding member 225 may be fixed to the receiver portion 220 using a pin as described above once the connection assembly 100 is fixed to the platform 200. Further, the intermediate sliding member 225 may be biased toward the retracted position, as shown in FIG. 5. The bias is such that an operator may overcome the bias force during connection of the platform 200 to the connection assembly 100 by pulling the lever 230. The bias would automatically pull the intermediate sliding member 225 to the retracted position once the wheels of the platform 200 lift off of the ground.

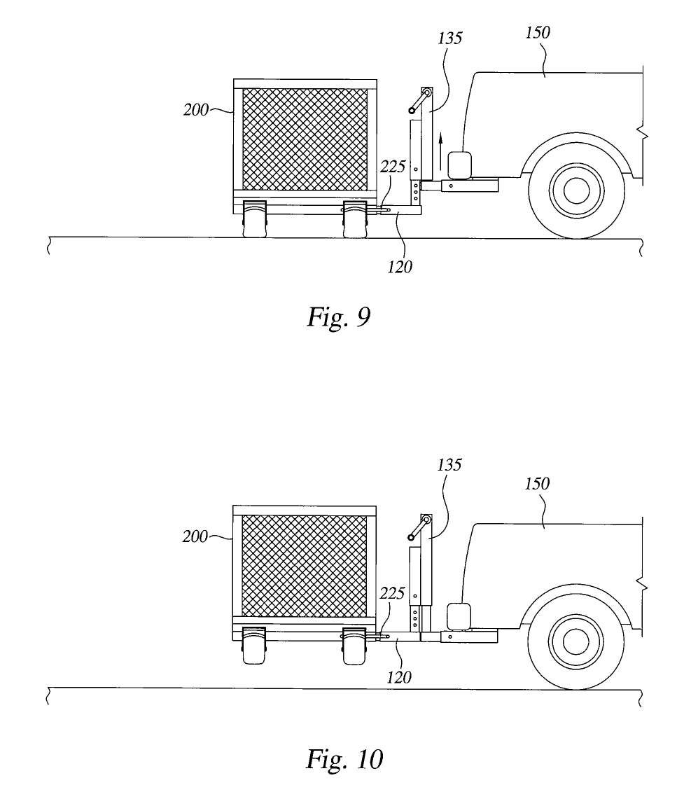

FIGS. 7-10 show how the platform 200 is typically installed at the rear of a vehicle 150. In FIG. 7, the connection assembly 100 is shown installed at the rear of a vehicle 150 and the platform 200 has been maneuvered to a location adjacent the vehicle 150 and the connection assembly 100. As stated, the platform 200 may be “side mounted” relative to the vehicle 150. In FIG. 8, the lower portion 105 of the connection assembly 100 has been adjusted to place the platform insert 120 at a location slightly lower than the platform receiver 220. In FIG. 9, the mechanical winch 135 is utilized to accurately place the platform insert 120 at a height equal to that of the platform receiver 220. Any side adjustments are made by simply rolling the platform 200 to move it relative to the receiver. Also in FIG. 9, the intermediate sliding member 225 is shown extended out to mate with the platform insert 120. Upon insertion, the intermediate sliding member 225 will be fixed to the connection assembly 100. Finally, in FIG. 10 the mechanical winch 135 has been used to lift the entire platform 200 to a height where the vehicle 150 can be safely operated. In order to release the platform 200, the process is basically reversed.

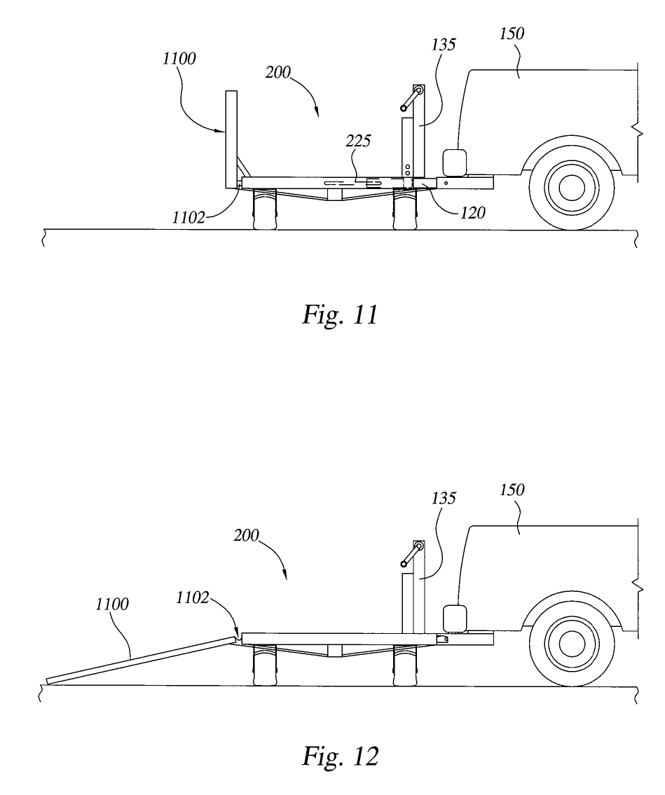

As shown in FIGS. 7-10, the platform 200 may include sides high enough to permit a variety of cargo to be carried. Typically, there is also a door or gate that can be opened or lowered to provide access to the cargo area of the platform. Further, the platform 200 may be a fully enclosed cargo carrier having one or more doors to provide access to the interior of the cargo area. Further, the platform 200 may have a flatbed configuration as shown in FIGS. 11-14.

FIG. 11 shows an additional and/or alternative embodiment of the platform 200. The platform 200 includes a ramp 1100. The ramp 1100 is shown in a locked position in FIG. 11 and a loading position in FIG. 12. In the locked position, the ramp 1100 is secure and may secure cargo being carried by the platform 200. In the locked position, the ramp 1100 is stationary relative to the platform 200 thereby allowing the vehicle 150 to move without the risk of damaging the ramp 1100. In the loading position, the ramp 1100 engages the ground and the platform 200. Thus, in the loading position, cargo may easily be moved and/or wheeled up the ramp 1100 and onto the platform 200. The ramp 1100 may be attached to the platform by a hinge 1102 which allows the ramp 1100 to pivotally move from the locked position to the loading position. As shown, the ramp 1100 is attached to the side of the platform 200 opposite the vehicle 150; however, it should be appreciated that the ramp 1100 may be located on any side of the platform 200 except the vehicle side. The ramp 1100 may include a telescopic portion, or folding portion, (not shown) adapted to extend the length of the ramp 1100 in the loading position.

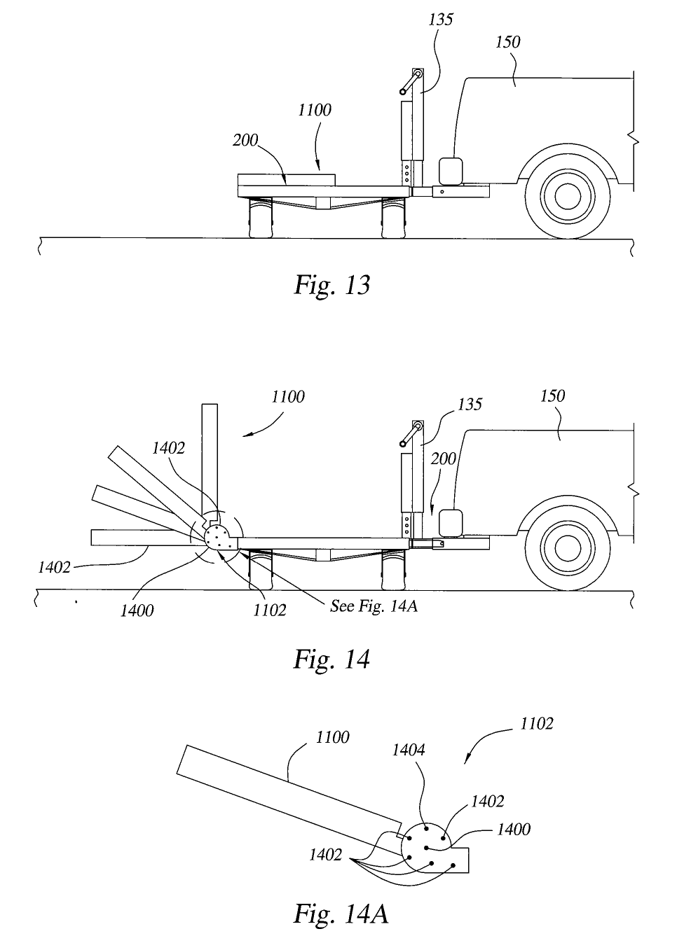

FIG. 13 shows an additional embodiment of the ramp 1100. In this embodiment, the ramp 1100 is adapted to lay substantially flat on the platform 200 when not in use. Further, the platform 200 may include a recess (not shown) adapted to house the ramp 1100 when the ramp 1100 is flat on the platform 200, thereby arranging the top of the platform 200 and the ramp 1100 in a substantially planar fashion when the ramp 1100 is flat on the platform 200.

The ramp 1100 and/or the winch may be run by one or more electric motors (not shown). The motors would allow an operator to automatically operate the ramp 1100 and/or the winch. This feature may be of particular importance for the assistance of the handicap. For example, a handicap person may be able to automatically lower the ramp 1100 then maneuver a wheel chair or motorized mobility assistance device, such as a scooter, onto the platform 200. The person may then automatically raise the ramp 1100 to the locked position. The person may then automatically raise the platform 200 as described above.

FIGS. 14 and 14A show the hinge 1102 having a plurality of manually adjustable positions. The hinge 1102 includes one or more hinge pins 1400, several apertures 1402, and a pin 1404. The pin 1404 is adapted to lock the ramp 1100 into a desired position by locking the pin 1404 in the aperture 1402. There may be any number of apertures 1402 depending on the desired amount of positions of the ramp 1100.

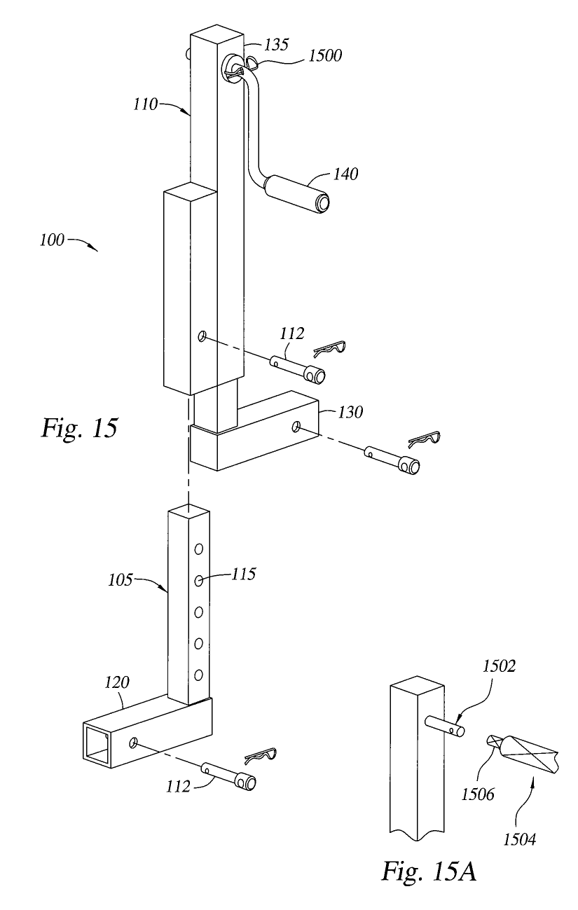

FIGS. 15 and 15A show an additional and/or alternative embodiment of the mechanical winch 135. The handle 140, as shown, is removable from the connector assembly 100 by removing a pin 1500. With the pin 1500 removed, the handle 140 may be removed from the connector assembly 110 as shown in FIG. 15A. The removal of the handle 140 exposes a shaft 1502 configured to operate the winch. The shaft 1502 is configured to be turned by a torquing member 1504, shown schematically. The end of the shaft 1502 is engaged by a torque connector 1506. The torque connector 1506 prevents relative rotation between the torque connector and the shaft 1502. Thus, as the torque connector 1506 is rotated, the shaft 1502 is rotated, thereby operating the winch in a similar manner to the handle 140. The torquing member 1504 may be any tool adapted to be rotated or to rotate the torque connector 1506 including, but not limited to a drill, a handle, a vice grip, an electric motor, pliers, or wrenches. The torque connector 1506 can be any member adapted to grip the shaft 1502 including, but not limited to, a bolt receiver, a drill chuck, a profiled female member, a profiled male member, jaws of vice grips, pliers, or wrenches. The shaft 1502, as shown, is cylindrical; however, it should be appreciated that it may have any cross sectional shape configured to allow a torquing member to rotate the shaft by rotating the torque connector including, but not limited to, a hexagon, an octagon, pentagon, polygon, rectangle, a square, a triangle, or a profiled shaft. Further, it should be appreciated that the handle 140 may be eliminated from this configuration, thereby allowing an operator to simply connect the torque connector 1506 to the shaft 1500. The operator may then operate the torquing member 1504 in order to rotate the torque connector 1506 and the shaft 1500, thereby operating the winch.

In operation, the platform 200 may be rolled to a location where cargo is to be loaded on to the platform 200, for example, a retail store. The cargo is then loaded onto the platform 200 and secured in the platform 200 thereby preventing any damage to the cargo. The platform 200 may then be wheeled to the location of the vehicle 150. The connection assembly 100 may then be coupled to the vehicle 150 or the platform 200. The platform 200 may be aligned with trailer hitch of the vehicle 150 by rolling the platform 200. With the platform 200 aligned with the trailer hitch, the connector assembly 100 may be height adjusted, as described above, in order to horizontally align the connector assembly 100 with the trailer hitch or the receiver portion 220. The intermediate sliding member 225 may be extended in order to engage the connector assembly 100 with the trailer hitch or the receiver portion 220. The connector assembly 100 may then be secured to the vehicle 150 or the platform 200. With the connector assembly 100 connected to the vehicle 150 and the platform 200, the winch may be manipulated in order to raise the platform 200 off of the ground. The vehicle 150 may then be safely operated without damaging the platform 200 or the cargo.

While the foregoing is directed to embodiments of the present invention, other and further embodiments of the invention may be devised without departing from the basic scope thereof, and the scope thereof is determined by the claims that follow.

1. A cargo carrying system, comprising:
a cargo platform, the platform including roller members on an underside thereof to facilitate movement of the platform along the ground;
a platform receiver located at one side of the platform, the platform receiver for mating the platform with a vehicle; and
a connection assembly, the connection assembly including:
a platform insert member for connection of the assembly to the platform;
a vehicle insert member for connection of the assembly to a vehicle; and
at least one height adjustment member for changing the height of the platform insert relative to the vehicle insert.

2. The system of claim 1, wherein the platform is rectangular in shape with two front and two rear rollers, the front rollers pivotable together for turning the platform and the rear rollers fixed parallel to the longitudinal axis of the platform.

3. The system of claim 1, wherein the platform insert includes a slidable intermediate member telescopically extendable from the platform receiver for mating with the platform insert member.

4. The system of claim 1, wherein the at least one height adjustment member includes a pin and an aperture height adjustment member.

5. The system of claim 1, wherein the at least one height adjustment member includes a mechanical winch.

6. The system of claim 1, further comprising a handle for pulling the platform along the ground.

7. A cargo carrying system, comprising:
a platform for supporting cargo;
a plurality of wheels coupled to an underside of the platform and configured to facilitate movement of the platform along the ground; and
a connection assembly, the connection assembly comprising:
a platform connector for connecting the connector assembly to the platform;
a vehicle connector for connecting the connector assembly to a vehicle; and
a height adjustment member configured to lift the platform off of the ground after the connector assembly is connected to the platform and the vehicle.

8. The cargo carrying system of claim 7, further comprising a second height adjustment member of the connection assembly adapted to adjust the vertical location of the platform connector.

9. The cargo carrying system of claim 8, wherein the height adjustment member is a mechanical winch.

10. The cargo carrying system of claim 7, further comprising a handle pivotally coupled to the platform and configured to allow an operator to manipulate the platform when the platform is on the ground.

11. The cargo carrying system of claim 7, further comprising an intermediate extendable member between the platform and the platform connector and configured to adjustably connect the platform to the platform connector.

12. The cargo carrying system of claim 11, wherein the extendable member is moveably connected to the platform and extends into engagement with the platform connector.

13. The cargo carrying system of claim 11, further comprising a lever for manipulating the extendable member.

14. The cargo carrying system of claim 7, wherein the platform further comprises an enclosed cargo space having at least one access door.

15. The cargo carrying system of claim 7, wherein the platform comprises a flatbed platform.

16. The cargo carrying system of claim 7, further comprising a ramp pivotally coupled to the platform and adapted to facilitate loading of cargo onto the platform.

17. The cargo carrying system of claim 16, further comprising an electric motor configured to raise and lower the ramp.

18. The cargo carrying system of claim 17, further comprising a second electric motor configured to operate the height adjustment member.

19. A carrier mountable onto a trailer hitch of a vehicle comprising:
a frame and base, together defining a platform structure;
a trailer hitch connector operatively connected to the platform structure such that an axis of the trailer hitch connector is substantially parallel to a plane of the platform structure;
a plurality of wheels operatively connected to the platform structure, the wheels each rotatable about an axis substantially parallel to the axis of the trailer hitch connector; and
an adjustable link operatively connected to the trailer hitch connector, the link having a selectively variable effective dimension in a direction substantially perpendicular to the axis of the trailer hitch connector.
